(19) United States
(12) Patent Application Publication
(10) Pub. No.: US 2015/0258658 A1
(43) Pub. Date: Sep. 17, 2015

(54) Hand-Held Tool Apparatus with a Braking Device for Braking a Machining Tool

(71) Applicant: Hilti Aktiengesellschaft, Schaan (LI)

(72) Inventors: Adrian Steingruber, Schwabmuenchen (DE); Ralf Greitmann, Kaufering (DE); Florian Leistner, Neustadt (DE)

(73) Assignee: Hilti Aktiengesellschaft, Schaan (LI)

(21) Appl. No.: 14/433,331

(22) PCT Filed: Oct. 1, 2013
(86) PCT No.: PCT/EP2013/070415

§ 371 Date: Apr. 2, 2015

(30) Foreign Application Priority Data
Oct. 3, 2012 (DE) 10 2012 218 071.0

(51) Int. Cl. B24B 47/26; B27B 5/38; B27B 17/08; F16D 49/10

(52) U.S. Cl. CPC B24B 47/26; F16D 49/10; B27B 5/38; B27B 17/083

(57) ABSTRACT

A hand-guided tool apparatus having a braking device for braking a machining tool is disclosed. The tool includes a rear handle for operating the tool apparatus, a drive device for driving the machining tool about an axis of rotation, a belt brake including a brake drum and a brake belt which is wrapped around the brake drum, and an operating device including a gas switch for activation of the drive device and a safety switch for unlocking the gas switch. The gas switch and the safety switch are disposed on the rear handle. The operating device additionally includes a brake switch, which is separate from the gas switch and from the safety switch, for activating the belt brake, and which is disposed on the rear handle and is connected to the brake belt by a transmission device.

This application claims the priority of International Application No. PCT/EP2013/070415, filed Oct. 1, 2013, and German Patent Document No. 10 2012 218 071.0, filed Oct. 3, 2012, the disclosures of which are expressly incorporated by reference herein.

### BACKGROUND AND SUMMARY OF THE INVENTION

The present invention relates to a hand-held tool apparatus having a braking device for braking a machining tool.

The term “tool apparatus” in the context of the present invention includes all tool apparatuses that drive a machining tool about an axis of rotation during machining of a workpiece. Typical examples of such tool apparatuses include a disk grinder, an angle grinder, a circular saw, a chainsaw, and a core drilling device. The term “hand-held tool apparatuses” refers to those that are guided by the operator at least partially by hand during the machining of a workpiece. In addition to tool apparatuses guided over the workpiece directly by the operator, tool apparatuses mounted on a guide carriage are also included among the hand-held tool apparatuses. The tool apparatus is then operated by means of a mechanical or electrical remote operating device, and the guide carriage together with the tool apparatus is guided by the operator by hand over the workpiece.

DE 36 39 650 A1 discloses power chainsaws having a safety brake and an overrun brake. Both brakes operate the same mechanical band brake having a brake drum and a brake belt, which is wrapped around the brake drum. The safety brake is a safety device, which is required for power chainsaws and which stops the saw chain within 150 milliseconds without action by the operator in the event of severe recoil of the power chainsaw. In addition, the safety brake can be released manually by the operator by means of a safety hand strap. The safety hand strap is arranged between the front handle and the saw chain and is operated by a pivoting movement in the direction of the saw chain. The front handle is arranged between the saw chain and a motor housing. In addition to the front handle, the power chainsaws have a rear handle, which is arranged on the side of the front handle facing away from the saw chain. The overrun brake serves to reduce the stopping time of the saw chain by a few seconds. The overrun brake consists of a brake switch and a transmission device (e.g., Bowden cable), which is connected to the brake switch and the brake belt of the belt brake. With the known power chainsaws, the brake switch for the overrun brake is integrated into the gas switch for operating a drive device for the saw chain or into the safety switch for unlocking the gas switch, with both switches being arranged on the rear handle. The gas switch is arranged on the inside of the rear handle and the safety switch is arranged on the outside.

Operation of the overrun brake by means of the safety switch has the disadvantage for hand-guided tool apparatuses that the operator must let go of the rear handle in order to operate the overrun brake. When the safety switch is activated, the belt brake is opened and the machining tool can be driven (operating position), and when the safety switch is not activated the belt brake is arranged in the brake position. Operation of the safety brake by means of the hand safety strap on the front handle has the disadvantage that the operator must let go of the front handle in order to pivot the hand safety strap forward in the direction of the machining tool. In particular in the case of hand-guided tool apparatuses having machining tools with a high mass inertia, the tool apparatus has a strong pitching movement when braking due to the mass inertia of the machining tool, which thus constitutes the risk of injury for the operator. The higher the mass inertia of the machining tool, the greater is the pitching movement of the tool apparatus in braking. The pitching movement of the tool apparatus is increased when the operator lets go of the front or rear handle in braking the tool apparatus.

The object of the present invention is to develop a braking device for braking a machining tool, in which the risk of jerking movements in braking the hand-guided tool apparatus is reduced. In addition, the lifetime of the braking device is to be increased.

According to the invention, a brake switch designed separately from the gas switch and from the safety switch is provided for operating the belt brake, wherein the brake switch is arranged on the rear handle and is connected to the first end of the brake belt by means of a transmission device. The brake switch, which is designed separately, has the advantage that each switch can be operated separately by the operator and it is not necessary to let go of the rear handle in order to operate the belt brake, for example, by releasing the safety switch. Due to the separate design of the switches, it is ensured that the operator is gripping the handle while braking the tool apparatus, and the risk of jerking movements while braking is reduced. The arrangement of the brake switch on the rear handle has the advantage that the tool apparatus can be operated with one hand on the rear handle. Furthermore, guidance of the tool apparatus on the front and rear handles, while braking is possible in such a way that the risk of jerking movement while braking is reduced.

The gas switch and the brake switch are preferably arranged on the inside of the rear handle, and the safety switch is arranged on the outside of the rear handle. The arrangement of the gas switch and the brake switch on the inside of the rear handle has the advantage that the rear handle need not be released in order to release the switch and the risk of jerking movements is reduced. The safety switch for unlocking the gas switch may be arranged on the outside of the rear handle with no problem because no function is carried out when the safety switch has been released. Therefore, it is not necessary to release the rear handle when operating the tool apparatus.

The gas switch and the brake switch are preferably designed to rotate about parallel axes of rotation, and the brake switch is adjustable between a basic position with a fully operable belt brake and an end position with a fully open belt brake. The basic position is the position of the brake switch in which no force is acting on the brake switch by the operator input. The end position refers to the position of the brake switch, in which the operator has rotated the brake switch to the maximum extent about its axis of rotation. The positions between the basic position and the end position are referred to as intermediate positions, wherein the brake switch is operated by application of force by the operator in all intermediate positions. The belt brake is actively opened by the operator by applying a force to the brake switch; the belt brake is closed if the operator does not apply a force to the brake switch.

In a first particularly preferred embodiment, rotation of the gas switch is enabled in the end position of the brake switch, and rotation of the gas switch is blocked in the basic position and in all intermediate positions of the brake switch between the basic position and the end position. The gas switch cannot be operated as long as the belt brake is not fully open. This embodiment reduces wear on the belt brake because the gas switch can be operated only when the belt brake is fully open in the end position.

In a second particularly preferred embodiment, a brake switch arranged in an intermediate position between the basic position and the end position enables the rotation of the gas switch from the basic position to the intermediate position and blocks the rotation of the gas switch from the intermediate position to the end position. This embodiment allows the operator to play with the gas switch and the brake switch. The possibility of operating the gas switch when the belt brake is not fully open allows the operator to shorten the warm-up phase of a drive motor in the startup phase of the tool apparatus through repeated short-term increases in the rotational speed and allows the operator to achieve a stable engine running at the operating temperature more rapidly. Due to the fact that the allowed rotational speed of the drive device depends on the opening state of the belt brake, the wear on the belt brake is reduced in comparison with an embodiment in which the drive device can be operated with the belt brake operated at the maximum rotational speeds. The maximum rotational speeds for the drive device can be set by means of the gas switch only when the belt brake is fully open.

The brake switch preferably has in particular a stop which forms a form-fitting connection with a stop on the gas switch. The form-fitting connection between the brake switch and the gas switch prevents the operator from being able to operate the drive device by means of the gas switch at maximum rotational speeds when the belt brake is activated and does so in a mechanically simple manner. This embodiment prevents unnecessary wear on the belt brake due to simultaneous acceleration by means of the gas switch and braking by means of the brake switch.

In a preferred embodiment, a rotatably mounted brake lever is connected between the brake belt and the transmission device such that the brake lever is prestressed by means of a brake spring. A prestress, which is exerted on the brake lever by means of the brake spring, causes a permanent tensile force to be applied to the brake belt. The restoring force of the brake spring causes the brake lever to be rotated back into its basic position when no external force is acting on it.

In a preferred embodiment, a rotatably mounted compensating device is connected between the transmission device and the brake switch. With increasing use of the belt brake, the dimensions of the brake belt and the brake drum change because of wear. As a result, the brake spring, by means of which the brake lever is prestressed, contracts to a great extent and rotates the brake lever over its original basic position in the direction of the brake spring. The transmission device, which is connected to the brake lever at a first end and to the compensating device at a second end, is initially stressed by the brake lever and rotates the compensating device about its axis of rotation. The rotatably mounted compensating device between the transmission device and the brake switch in turn transmits the movement of the brake switch to the belt brake and, on the other hand, can compensate for the changes in length in the belt brake. The braking effect of the belt brake subsides somewhat with an increase in wear but it is sufficient for braking the machining tool. A drastic decline in the braking effect occurs when the braking distance of the brake switch no longer completely compensates for the increase in length in the belt brake, and braking of the machining tool is no longer possible. The braking distance of the brake switch is increased by the additional distance of the compensating device. The compensating device increases the lifetime of the belt brake due to the additional braking distance. The belt brake must be replaced when the increase in the length of the belt brake has also compensated for the additional braking distance of the compensating device due to wear.

The compensating device preferably comprises in particular a lever, which is mounted to rotate and is connected to the transmission device, and a spring element, which is connected to the brake switch at the first end and is in contact with the lever under a prestress at the second end. The design of the compensating device comprised of a lever and a spring element is inexpensive and can be implemented easily.

The spring element is preferably designed in particular as a plate spring and a carrier for the plate spring is provided on the brake switch. The second end of the plate spring, which is in contact with the lever, preferably has a shape that is complementary to that of the carrier of the brake switch in particular. Due to the complementary design of the carrier on the brake switch and the second end of the plate spring, the transfer of torque from the brake switch to the compensating device is improved. The torque is transferred in a defined manner over the surfaces of the carrier and the plate spring.

The spring stiffness of the spring element is in particular preferably much lower than the spring stiffness of the brake spring. The spring stiffness of the spring element must exceed the frictional forces in the transmission device. Since the spring element acts opposite the brake spring, the spring stiffness of the spring element should be as low as possible in comparison with the brake spring. A high spring stiffness of the spring element would have to be compensated by the brake spring, and the brake spring would have to be designed to be stiffer accordingly.

In a preferred embodiment, a tension spring is connected between a second end of the brake belt and a housing part of the tool apparatus. The tension spring between the brake belt and the housing part prevents the brake belt from being blocked on the brake drum and/or it quickly stops the blocking of the brake belt. A tension force is applied to the brake belt by means of the brake switch and the transmission device. Due to the increasing friction effect between the curved surfaces of the brake belt and the brake drum, the tension force on the second end of the brake belt increases and the sliding friction of the brake belt on the brake drum develops into an adherence. Due to the increase in the tension force on the brake belt, a point is reached at which the tension force on the second end of the brake belt increases the force of the tension spring and the tension spring is stretched. Due to the stretching of the tension spring, the tension force acting on the second end of the brake belt is reduced and the adherence of the brake belt to the brake drum changes into a sliding friction, which cancels the blocking of the brake drum. As soon as the tension force drops below the force of the tension spring, the tension spring contracts and the brake belt slides over the brake drum.

The maximum stretching of the tension spring is preferably limited by a first stop in particular. Overstretching of the tension spring is reliably prevented by the limitation on the maximum stretching of the tension spring, so that the tension spring has little or no wear and can return to its basic position.

The minimum stretching of the tension spring is preferably limited by a second stop in particular, wherein the tension spring is also prestressed at minimal stretching. The limitation on the minimum stretching of the tension spring ensures that the tension spring will return to its basic position.

The brake belt preferably has a stop element in particular, which can be displaced between the first stop and the second stop. The stop element is arranged on the second end of the brake belt facing the tension spring. The deflection of the tension spring is limited due to the displaceability of the stop element between the stops. Overstretching of the tension spring is reliably prevented, so that the tension spring has little or no wear and can return to its basic position.

The spring stiffness of the tension spring is in particular preferably much greater than the spring stiffness of the brake spring. The tension spring is designed to be much stiffer than the brake spring to achieve the effect that the tension spring is stretched only in blocking of the brake drum. As long as the brake belt slides over the brake drum, the tension spring is not arranged in its basic position and has no effect on the belt brake. The spring stiffness of the tension spring is designed so that the tensile force on the second end of the brake belt in blocking the brake belt exceeds the spring stiffness of the tension spring, and the spring stiffness of the tension spring exceeds all other forces occurring during normal braking operation.

Exemplary embodiments of the invention are described below on the basis of the drawings. These do not necessarily represent the exemplary embodiments drawn to scale but instead the drawings are drawn schematically and/or in a slightly distorted form when this serves the purpose of illustration. With regard to supplementation of the teachings that can be seen directly from the drawings, reference is made to the relevant prior art. It should be recalled here that a variety of modifications and changes with regard to the shape and details of an embodiment can be made without deviating from the general idea of the invention. The features of the invention disclosed in the drawings and in the claims may be essential for the refinement of the invention either individually or in any combination. Furthermore, all combinations of at least two features disclosed in the description, the drawings and/or the claims fall within the scope of the invention. The general idea of the invention is not limited to the precise form or detail of the preferred embodiment, which is shown and described below or limited to an object that would be restricted in comparison with the subject matter claimed in the claims. With the given dimension ranges, values within the stated limits should also be disclosed as limit values and may be used and claimed as desired. For the sake of simplicity, the same reference numerals are used for identical or similar parts or parts with an identical or similar function.

### BRIEF DESCRIPTION OF THE DRAWINGS

FIG. 1 shows a hand-guided tool apparatus according to the invention, designed as a disk grinder having a braking device for braking a cutting disk and an operating device for the disk grinder;

FIGS. 2A, B show the braking device of the disk grinder of FIG. 1 consisting of a mechanical belt brake with an antiblocking device (FIG. 2A) and the antiblocking device in detail (FIG. 2B);

FIGS. 3A, B show the operating device of the disk grinder of FIG. 1 with a gas switch, a safety switch and a brake switch in a basic position with the belt brake activated (FIG. 3A) and in an end position of the brake switch with the belt brake open and the gas switch and the safety switch activated (FIG. 3B); and

FIG. 4 shows the braking device of the disk grinder of FIG. 1 in the basic position of the brake switch with a belt brake that has been modified due to wear.

### DETAILED DESCRIPTION OF THE DRAWINGS

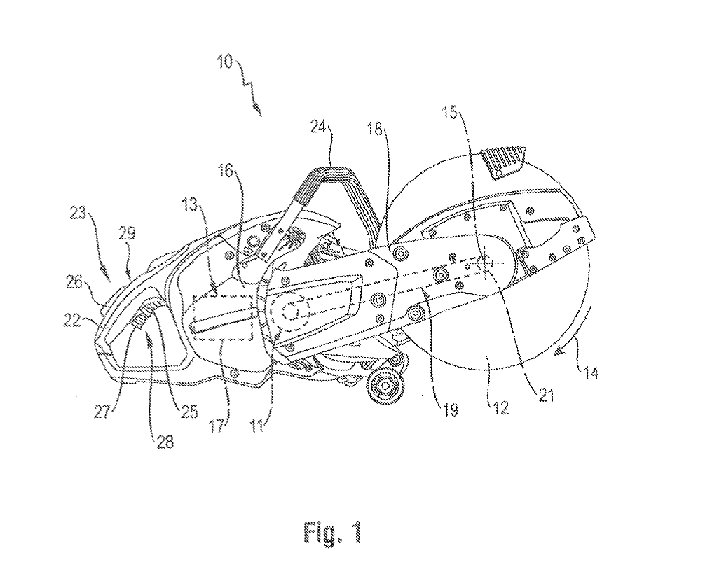

FIG. 1 shows a hand-guided tool apparatus 10 according to the invention, which is designed in the form of a disk grinder, with a braking device 11 for braking a drive device in a three-dimensional representation.

The disk grinder 10 has a machining tool, which is designed as a cutting disk 12, which is driven by a drive device 13 in one direction of rotation 14 about an axis of rotation 15. The term “drive device” summarizes all the drive components for the cutting disk 12. The drive device 13 of the disk grinder 10 shown in FIG. 1 comprises a drive motor 17, which is arranged in a motor housing 16, a belt drive 19, which is arranged in a carrying arm 18, and an output shaft 21 on which the cutting disk 12 is mounted. As needed, additional drive components may be connected between the drive motor 17 and the belt drive 19.

To operate the disk grinder 10, a first handle 22 is provided and has an operating device 23; this is embodied as a so-called rear handle in the exemplary embodiment shown in FIG. 1. The rear handle is a handle arranged on the side of the motor housing 16 facing away from the cutting disk 12. Alternatively, the first handle 22 may be designed as a so-called top handle, which is arranged above the motor housing 16. To guide the disk grinder 10, a second handle 24, which is arranged between the cutting disk 12 and the first handle 22, is also provided in addition to the first handle 22. The second handle 24 is embodied as a tube handle in the exemplary embodiment shown in FIG. 1 or, as an alternative, it may be designed in one piece with the motor housing 16. Regardless of a rear handle or top handle arrangement, the first handle 22 is always situated in the rear region of the tool apparatus 10 and therefore is behind the second handle 24, so it is possible to speak of a rear handle 22 and a front handle 24 in general.

The operating device 23 comprises a gas switch 25 for actuation of the drive device 13, a safety switch 26 for unlocking the gas switch 25 and a brake switch 27 for actuation of the braking device 11. The actuating device 23 is arranged on a rear handle 22 and is actuated by the operator with one hand. The gas switch 25 and the brake switch 27 are arranged on an inside 28 of the rear handle 22 and are activated by using the index finger (gas switch 25) and the middle finger (brake switch 27), for example. The safety switch 26 is arranged on the outside 29 of the rear handle 22 and is actuated with the palm of the hand, i.e., the inside of the hand.

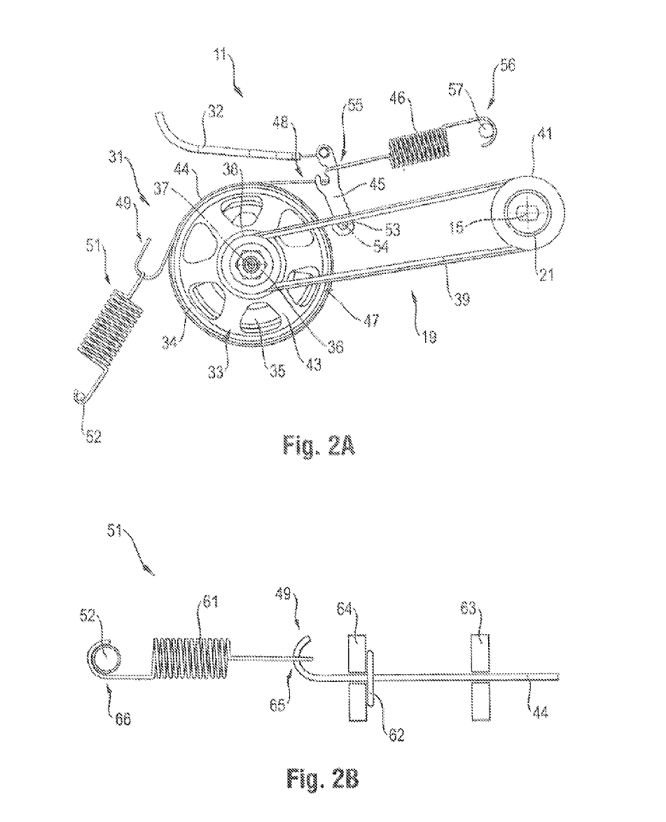

FIG. 2A shows the braking device 11 of the disk grinder 10 which, in addition to the brake switch 27 (shown in FIG. 1), consists of a mechanical belt brake 31 and a transmission device 32. The transmission device 32 is embodied as a Bowden cable in FIG. 2A and transmits a movement of the brake switch 27 to the belt brake 31, which acts on a centrifugal clutch 33 of the drive device 13. Alternatively, the transmission device 32 may be embodied as a traction cable, a rod or the like.

The centrifugal clutch 33 is arranged between the drive motor 17 and the belt drive 19 and ensures that the cutting disk 12 does not rotate at low rotational speeds, for example, when idling or when starting the disk grinder 10. The centrifugal clutch 33 has a clutch case 34 against which the centrifugal weights 35 are pressed outward during operation because of the centrifugal force. The drive motor 17 drives a crankshaft 36 about an axis of rotation 37. The clutch case 34 is in a rotationally fixed connection with a drive disk 38 mounted to rotate on the crankshaft 36. A drive belt 39 is guided via the drive disk 38 and an output disk 41 which is mounted on the output shaft 21. The drive disk 38, the drive belt 39 and the output disk 41 form the belt drive 19.

The belt brake 31 comprises a brake drum 43, a brake belt 44, a brake lever 45 and a brake spring 46. The clutch case 34 of the centrifugal clutch 33 at the same time forms the brake drum 43 of the belt brake 31. The brake belt 44 is wrapped around the brake drum 43 on its outer peripheral wall 47. The brake belt 44 and the brake drum 43 form friction partners, which cooperate in braking and bring the clutch case 34 to a standstill. A prestress is exerted on the brake lever 45 by means of the brake spring 46, causing a permanent tensile force to be applied to the brake belt 44. The restoring force of the brake spring 46 causes the brake lever 45 to be rotated back into its basic position when no external force is acting on it. The braking device 11 is designed, so that the belt brake 31 is open when the brake switch 27 is activated and is closed when the brake switch 27 is released.

FIG. 2A shows an exemplary embodiment in which the clutch case 34 of the centrifugal clutch 33 forms the brake drum 43 of the belt brake 31. Alternatively, the brake drum maybe designed as a separate component and is attached to a housing part of the disk grinder 10 by means of an adaptor plate, for example. Integration of the brake drum 43 into the clutch case 34 permits a compact design with simultaneous saving of weight for the tool apparatus. The separate design has the advantage that the belt brake can be retrofitted without any great renovation effort on tool apparatuses.

The brake belt 44 has a first end 48 and a second end 49. The first end 48 of the brake belt 44 is hooked on the brake lever 45. The second end 49 is connected to an antiblocking device 51 which is fixedly connected at the other end with a housing part 52 of the disk grinder 10. The brake lever 45 is mounted to rotate about a bolt 53, which is connected to the housing part 52 and secures an axis of rotation 54. The brake spring 46 has one free end 55 and one fixed end 56, wherein the free end 55 is hooked on the brake lever 45 and the fixed end 56 is attached to the housing part 52 by a bolt 57.

FIG. 2B shows the design of the antiblocking device 51 of the belt brake 31 in detail. The antiblocking device 51 comprises a tension spring 61, a stop element 62, a first stop 63 and a second stop 64. The stop element 62 is connected to the brake belt 44 and can be displaced between the first stop 63 and the second stop 64. The tension spring 61 has a free end 65 and a fixed end 66. The free end 65 is connected to the second end 49 of the brake belt 44, and the fixed end 66 is attached to the housing part 52. As an alternative to the antiblocking device 51, the second end 49 of the brake belt 44 may be designed as a fixed end and is fixedly connected to the housing part 52 of the disk grinder 10 by means of a bolt, for example.

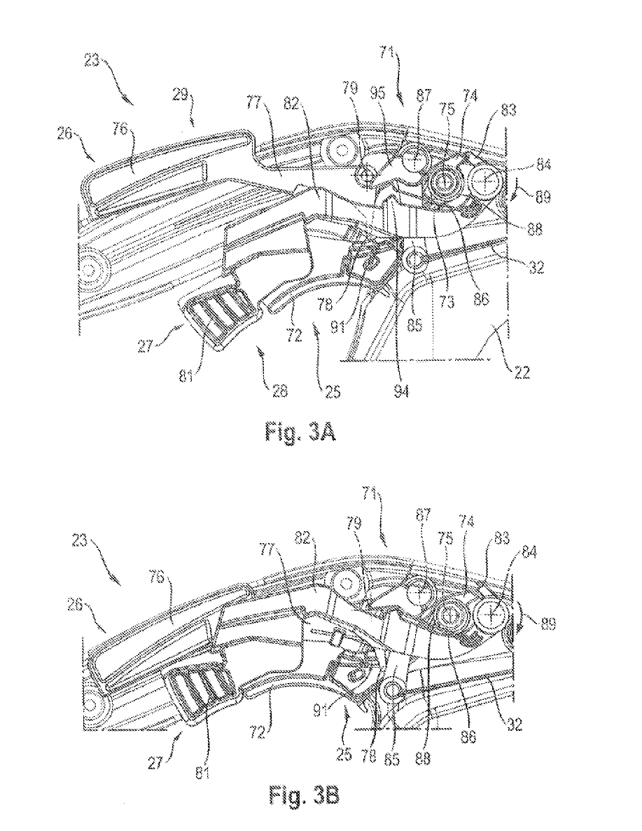

FIGS. 3A, B show the operating device 23 of the disk grinder 10 with the gas switch 25, the safety switch 26 and the brake switch 27 in a basic position of the brake switch 27 with the belt brake 31 activated (FIG. 3A) and in an end position of the brake switch 27 with the belt brake 31 open and with the gas switch and the safety switch 25, 26 activated (FIG. 3B). The operating device 23 has, in addition to the switches 25, 26, 27, a device 71, which compensates for wear on the belt brake 31 and is referred to as a compensating device.

The gas switch 25 consists of a handle section 72, a connecting section 73 and a stop 74 and is designed to be rotatable about a first axis of rotation 75. The safety switch 26 comprises a handle section 76, a connection section 77 and a stop 78 and is designed to be rotatable about a second axis of rotation 79. The brake switch 27 consists of a handle section 81, a connecting section 82 and a top 83 and is designed to be rotatable about a third axis of rotation 84. The compensating device 71 comprises a lever 85 and a spring element 86, designed as a plate spring, and is designed to be rotatable about an axis of rotation 87. The movement of the brake switch 27 is transferred by means of the lever 85 to the transmission device, which is designed as a Bowden cable 32. During the rotation of the brake switch 27, the connecting section 82 comes to a stop against the lever 85 and rotates the lever 85 about the axis of rotation 87 in the same direction. At one first end, the Bowden cable 32 is connected to the brake lever 45 (FIG. 2), and at a second end, the Bowden cable is connected to the lever 85. The Bowden cable 32 is put under tension by the rotation of the lever 85 about the axis of rotation 87.

The handle sections 72, 81 of the gas switch 25 and of the brake switch 27 are arranged on the inside 28 of the rear handle 22 and are activated by the operator using his index finger and middle finger, for example. The handle section 76 of the safety switch 26 is arranged on the outside 29 of the rear handle 22 and is activated by the operator using the palm of his hand, for example. The rear handle 22 consists of two housing shells that are joined together. In one or both of the two housing shells, holding elements are formed with switches 25, 26, 27 and the lever 85 attached to them. The switches 25, 26, 27 and the lever 85 are designed to rotate about the holding elements. The axes of rotation 75, 79, 84, 87 of the switches 25, 26, 27 and the compensating device 71 run parallel to one another.

By means of a torsion spring 88, a prestress is exerted on the gas switch 25 and on the safety switch 26. A first end of the torsion spring 88 is connected to the gas switch 25 and a second end is connected to the safety switch 26. The restoring force of the torsion spring 88 causes the gas switch 25 and the safety switch 26 to be returned into their basic positions when no external force is acting on them.

In the basic position of the brake switch 27 shown in FIG. 3A, the braking device 11 of the disk grinder 10 is active, i.e., the belt brake 31 blocks the clutch case 34 of the centrifugal coupling 33. The stop 83 of the brake switch 27 is in contact with the stop 74 on the gas switch 25 and blocks rotation of the gas switch 25. Furthermore, the stop 78 of the safety switch 26 is in contact with the connecting section 73 of the gas switch 25. To activate the drive device 13 of the disk grinder 10 with the help of the gas switch 25, the belt brake 31 must be released by means of the brake switch 27 and the safety switch 26 must be activated (FIG. 3B). The order in which the brake switch 27 and the safety switch 26 are activated does not play a role here.

In a first variant, the brake switch 27 is activated first. In activation of the handle section 81, the brake switch 27 is rotated about the third axis of rotation 84 in a direction of rotation 89. The stop 83 on the brake switch 27 releases the stop 74 on the gas switch 25 by the rotation of the brake switch 27. The gas switch 25 is also blocked by the stop 78 on the safety switch 26, which is in contact with the connecting section 73 of the gas switch 25. When the safety switch 26 on the handle section 76 is activated, the safety switch 26 is rotated about its axis of rotation 79. During the rotation about the axis of rotation 79, the stop 78 on the safety switch 26 dips into a link 91 on the gas switch 25. The blocking of the gas switch 25 by the stop 78 on the safety switch 26 is cancelled. The gas switch 25 can then be activated by means of the handle section 72.

In a second variant, first the safety switch 26 is activated. Upon activation of the handle section 76, the safety switch 26 is rotated about its axis of rotation 79, while the stop 78 on the safety switch 26 dips into the link 91 on the gas switch 25 and releases the gas switch 25. The gas switch 25 is also blocked by the stop 83 on the brake switch 27, which is in contact with the stop 74 of the gas switch 25. When the brake switch 27 is rotated in the direction of rotation 89 about its axis of rotation 84 by activation of the handle section 72, the stop 83 on the brake switch 27 releases the stop 74 on the gas switch 25. The gas switch 25 can then be activated by means of the handle section 72.

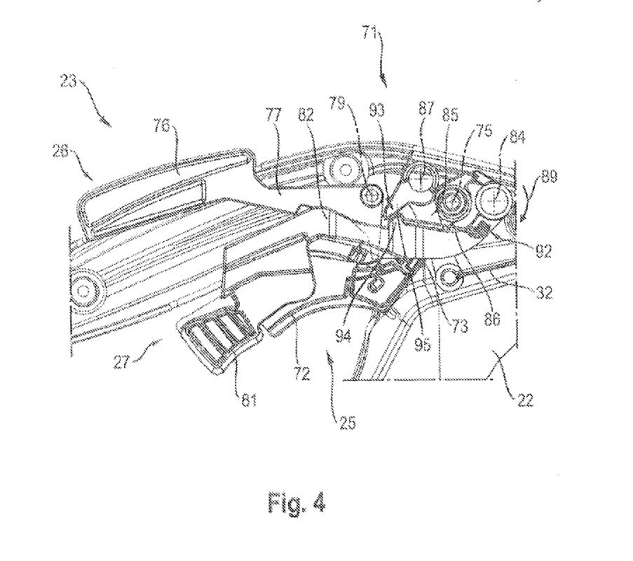

FIG. 4 shows the compensating device 71 of the braking device 11 in the basic position of the brake switch 27 with a belt brake 31 that has been altered due to wear. In comparison with that, FIG. 3A shows the braking device 11 in the basic position in the starting condition of the belt brake 31 without any wear.

With increasing use of the belt brake 31, the dimensions of the belt brake 44 and the brake drum 43 change due to wear, the length of the brake belt 44 increases and the diameter of the brake drum 43 decreases (FIG. 2). As a result, the brake spring 46 contracts more strongly and rotates the brake lever 45 in the direction of the brake spring 46 over its original basic position. The Bowden cable 32, which is connected to the brake lever 45, is put under tension.

To compensate for these changes in length of the brake belt 44 and the brake drum 43, the compensating device 71 is provided with the lever 85, which is designed to rotate about the axis of rotation 87, and the plate spring 86. The plate spring 86 comprises a first end 92 which is fixedly connected to the brake switch 27, and a second end 93 which is in contact with the lever 85 under prestress. On activation of the handle element 81, the brake switch 27 is rotated in the direction of rotation 89 about its axis of rotation 84. After this distance has been overcome, the brake switch 27 is stopped against the lever 85, and the two of them are rotated together about the respective axes of rotation 84, 87. Since the Bowden cable 32 is attached to the lever 85, the Bowden cable 32 is put under tension in the rotation of the lever 85, the brake lever 45 is rotated about its axis of rotation 54 and the brake spring 46 is stretched.

To simplify the entrainment of the lever 85 and the plate spring 86 by the connecting section 82 of the brake switch 27, a carrier 94 is provided on the connecting section 82 and a stop 95 is provided on the lever 85. Furthermore, the plate spring 86 on the second end 93 has a shape that is complementary to that of the carrier 94. In the exemplary embodiment in FIG. 4, the carrier 94 and the second end 93 of the plate spring 86 are designed in the form of triangle.

FIG. 3A shows the compensating device 71 in the basic position of the brake switch 27 in the starting condition of the belt brake 31. The distance between the carrier 94 and the stop 95 corresponds to the maximum possible change in length which can be compensated by the compensating device 71. Due to the compensating device 71, the operator must first overcome a blank distance in activating the brake switch 27. The movement of the brake switch 27 is transferred to the belt brake 31 by means of the Bowden cable 32 only when the brake switch 27 has come to a stop on the brake lever 85 and the lever 85 is rotated in the direction of rotation 89 about its axis of rotation 87. FIG. 4 shows the compensating device 71 in the basic position of the brake switch 27, in which the maximum possible change in length of the belt brake 31 is compensated by the compensating device 71. In the basic position, the carrier 94 is already in contact with the second end 93 of the plate spring 86 and the lever 85 is jointly rotated directly in activation of the handle section 81. There is no blank distance that must be overcome.

1-17. (canceled)

18. A hand-guided tool apparatus with a braking device for braking a machining tool, comprising:
a rear handle for operating the hand-guided tool apparatus;
a drive device, wherein the machining tool is drivable by the drive device around an axis of rotation;
a belt brake including a brake drum and a brake belt that wraps around the brake drum, wherein the brake belt has a first end and a second end;
an operating device including a gas switch for activation of the drive device and a safety switch for unlocking the gas switch, wherein the gas switch and the safety switch are disposed on the rear handle; and
a brake switch, wherein the brake switch is separate from the gas switch and from the safety switch, wherein the belt brake is activatable by the brake switch, and wherein the brake switch is disposed on the rear handle and is connected to the first end of the brake belt by a transmission device.

19. The hand-guided tool apparatus according to claim 18, wherein the gas switch and the brake switch are disposed on an inside of the rear handle and wherein the safety switch is disposed on an outside of the rear handle.

20. The hand-guided tool apparatus according to claim 18, wherein the gas switch and the brake switch are rotatable about parallel axes of rotation and wherein the brake switch is adjustable between a basic position with a completely activated belt brake and an end position with a completely open belt brake.

21. The hand-guided tool apparatus according to claim 20, wherein the gas switch is rotatable in the end position of the brake switch and is blocked in the basic position and in all intermediate positions of the brake switch between the basic position and the end position.

22. The hand-guided tool apparatus according to claim 20, wherein the brake switch arranged in an intermediate position between the basic position and the end position enables the rotation of the gas switch from the basic position to the intermediate position and blocks it from the intermediate position to the end position.

23. The hand-guided tool apparatus according to claim 22, wherein the brake switch has a stop which together with a stop on the gas switch forms a form-fitting connection.

24. The hand-guided tool apparatus according to claim 18 further comprising a rotatably mounted brake lever connected between the brake belt and the transmission device, wherein the brake lever is prestressed by a brake spring.

25. The hand-guided tool apparatus according to claim 18 further comprising a rotatably mounted compensating device connected between the transmission device and the brake switch.

26. The hand-guided tool apparatus according to claim 25, wherein the compensating device includes a rotatably mounted lever connected to the transmission device and a spring element, wherein the spring element is in contact with the brake switch on a first end and is in contact with the lever under prestress on a second end.

27. The hand-guided tool apparatus according to claim 26, wherein the spring element is a plate spring and wherein a carrier for the plate spring is provided on the brake switch.

28. The hand-guided tool apparatus according to claim 27, wherein the second end of the plate spring that is in contact with the lever has a shape that is complementary to a shape of the carrier.

29. The hand-guided tool apparatus according to claim 26 further comprising a rotatably mounted brake lever connected between the brake belt and the transmission device, wherein the brake lever is prestressed by a brake spring and wherein a spring stiffness of the spring element is lower than a spring stiffness of the brake spring.

30. The hand-guided tool apparatus according to claim 18 further comprising a tension spring that is disposed between the second end of the brake belt and a housing part of the hand-guided tool apparatus.

31. The hand-guided tool apparatus according to claim 30, wherein a maximum elongation of the tension spring is limited by a first stop.

32. The hand-guided tool apparatus according to claim 31, wherein a minimum elongation of the tension spring is limited by a second stop.

33. The hand-guided tool apparatus according to claim 32, wherein the brake belt has a stop element which is displaceable between the first stop and the second stop.

34. The hand-guided tool apparatus according to claim 30, further comprising a rotatably mounted brake lever connected between the brake belt and the transmission device, wherein the brake lever is prestressed by a brake spring and wherein a spring stiffness of the tension spring is greater than a spring stiffness of the brake spring.
